(19) United States
(12) Patent Application Publication
(10) Pub. No.: US 2026/0230968 A1
(43) Pub. Date: Aug. 6, 2026

(54) TIMING ADVANCED MEASUREMENT FOR CANDIDATE CELLS

(71) Applicant: QUALCOMM Incorporated, San Diego, CA (US)

(72) Inventors: Yan ZHOU, San Diego, CA (US); Fang YUAN, Beijing (CN); Jae Ho RYU, San Diego, CA (US); Changhwan PARK, San Diego, CA (US); Rebecca Wen-Ling YUAN, San Diego, CA (US); Jelena DAMNJANOVIC, Del Mar, CA (US)

(21) Appl. No.: 19/148,231

(22) PCT Filed: Feb. 17, 2023
(86) PCT No.: PCT/CN2023/076791

§ 371 Date: Jul. 15, 2025

(51) Int. Cl. H04W 36/08; H04W 36/00; H04W 36/04; H04W 74/0833

(52) U.S. Cl. CPC H04W 36/08; H04W 36/008355; H04W 36/04; H04W 74/0833

(57) ABSTRACT

Methods, systems, and devices for wireless communications are described. A user equipment (UE) may transmit a capability message indicating a first quantity of candidate cells supported by the UE for a first type of mobility procedure. The UE may receive, a control message indicating one or more candidate cells that correspond to a second quantity of candidate cells. The UE may generate before receiving a physical down-link control channel (PDCCH) order, a respective set of communication parameters for each candidate cell of the one or more candidate cells. The UE may receive the PDCCH order that instructs the UE to transmit a physical random access channel (PRACH) message to a candidate cell of the one or more candidate cells. The UE may transmit the PRACH message to the candidate cell in accordance with the respective set of communication parameters associated with the candidate cell.

### CROSS REFERENCE

The present Application is a 371 national phase filing of International PCT Application No. PCT/CN2023/076791 by ZHOU et al., entitled “TIMING ADVANCED MEASUREMENT FOR CANDIDATE CELLS,” filed Feb. 17, 2023, which is assigned to the assignee hereof, and which is expressly incorporated by reference in its entirety herein.

### FIELD OF TECHNOLOGY

The following relates to wireless communications, including timing advanced measurement for candidate cells.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support timing advanced measurement for candidate cells. For example, the described techniques enable a user equipment (UE) to reduce the latency associated with preparing the physical random access channel (PRACH) message. For instance, the UE may transmit a capability message that may indicate a quantity of candidate cells the UE supports. In response to the capability message, the UE may receive a control message from a source or serving cell indicating a set of candidate cells for the UE to prepare for a potential handover. The UE may proceed to preemptively (e.g., before a handover command or order) generate respective radio frequency (RF) scripts for each cell of the cells indicated by the control message. As such, when the UE receives a physical downlink control channel (PDCCH) order (e.g., from a serving cell), the UE may identify which of the indicated cells is the target cell indicated in the PDCCH order, and the UE may use the generated RF script associated with the candidate cell to apply transmission parameters for transmitting a PRACH message to the target cell. Additionally, or alternatively, the UE may transmit, in the capability message, an indication of a quantity of frequency bands (e.g., a maximum quantity) that the UE supports. The indication may indicate a quantity of bands, a list of bands that may support uplink and downlink communications with candidate cells, or both. Additionally, or alternatively, the UE may transmit, in the capability message, an indication of a time duration (e.g., a guard period) associated with preparing the PRACH message, which may be based on network conditions and on which, if any, RF scripts the UE has generated.

A method for wireless communications is described. The method may include transmitting a capability message indicating a first quantity of candidate cells supported by the UE for a first type of mobility procedure, receiving, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure, and receiving a downlink control channel order that instructs the UE to transmit a random access channel message to a candidate cell of the one or more candidate cells in accordance with the first type of mobility procedure.

An apparatus for wireless communications is described. The apparatus may include a processor, memory coupled with the processor, and instructions stored in the memory. The instructions may be executable by the processor to cause the apparatus to transmit a capability message indicating a first quantity of candidate cells supported by the UE for a first type of mobility procedure, receive, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure, and receive a downlink control channel order that instructs the UE to transmit a random access channel message to a candidate cell of the one or more candidate cells in accordance with the first type of mobility procedure.

Another apparatus for wireless communications is described. The apparatus may include means for transmitting a capability message indicating a first quantity of candidate cells supported by the UE for a first type of mobility procedure, means for receiving, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure, and means for receiving a downlink control channel order that instructs the UE to transmit a random access channel message to a candidate cell of the one or more candidate cells in accordance with the first type of mobility procedure.

A non-transitory computer-readable medium storing code for wireless communications is described. The code may include instructions executable by a processor to transmit a capability message indicating a first quantity of candidate cells supported by the UE for a first type of mobility procedure, receive, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure, and receive a downlink control channel order that instructs the UE to transmit a random access channel message to a candidate cell of the one or more candidate cells in accordance with the first type of mobility procedure.

Some examples of the method, apparatuses, and non-transitory computer-readable medium described herein may further include operations, features, means, or instructions for generating, before receiving the downlink control channel order, a respective set of communication parameters for each candidate cell of the one or more candidate cells and transmitting the random access channel message to the candidate cell of the one or more candidate cells in accordance with the respective set of communication parameters associated with the candidate cell.

In some examples of the method, apparatuses, and non-transitory computer-readable medium described herein, receiving the control message may include operations, features, means, or instructions for receiving, as part of the control message, an indication of a time duration to generate each respective set of communication parameters, where generating the respective set of communication parameters for each candidate cell of the one or more candidate cells may be based on the time duration.

Some examples of the method, apparatuses, and non-transitory computer-readable medium described herein may further include operations, features, means, or instructions for storing, at the UE, each respective set of communication parameters, where each respective set of communication parameters includes a gain stage setting, a radio frequency filter configuration, an envelope tracking configuration, a radio frequency switch configuration, or a combination thereof.

In some examples of the method, apparatuses, and non-transitory computer-readable medium described herein, transmitting the capability message may include operations, features, means, or instructions for transmitting, as part of the capability message, an indication of a threshold quantity of bands supported by the UE for transmission of the random access channel message.

In some examples of the method, apparatuses, and non-transitory computer-readable medium described herein, the indication includes a list of bands supported by the UE for transmission of the random access channel message and the indication indicates whether each band of the list of bands supports uplink transmission, downlink reception, or both.

In some examples of the method, apparatuses, and non-transitory computer-readable medium described herein, transmitting the capability message may include operations, features, means, or instructions for transmitting, as part of the capability message, an indication of a set of guard periods, where each guard period of the set of guard periods includes a respective duration between receiving the downlink control channel order and the UE transmitting the random access channel message.

In some examples of the method, apparatuses, and non-transitory computer-readable medium described herein, a first guard period of the set of guard periods may be associated with candidate cells included in the one or more candidate cells indicated by the control message and a second guard period of the set of guard periods may be associated with candidate cells excluded from the one or more candidate cells indicated by the control message, the first guard period being less than the second guard period.

In some examples of the method, apparatuses, and non-transitory computer-readable medium described herein, a third guard period of the set of guard periods may be associated with candidate cells associated with a same band as a current serving cell of the UE and a fourth guard period of the set of guard periods may be associated with candidate cells associated with a different band than the current serving cell, the third guard period being less than the fourth guard period.

In some examples of the method, apparatuses, and non-transitory computer-readable medium described herein, each guard period of the set of guard periods includes a single latency value indicative of the respective duration or a set of latency values indicative of the respective duration.

In some examples of the method, apparatuses, and non-transitory computer-readable medium described herein, each guard period of the set of guard periods may be associated with a respective candidate cell supported by the UE, a respective candidate cell group supported by the UE, or both.

In some examples of the method, apparatuses, and non-transitory computer-readable medium described herein, receiving the control message may include operations, features, means, or instructions for receiving a radio resource control (RRC) message, a medium access control control element (MAC-CE), or downlink control information (DCI).

In some examples of the method, apparatuses, and non-transitory computer-readable medium described herein, the second quantity of candidate cells may be less than or equal to the first quantity of candidate cells.

In some examples of the method, apparatuses, and non-transitory computer-readable medium described herein, the first type of mobility procedure may be a layer 1 (L1) mobility procedure or a layer 2 (L2) mobility procedure.

Some examples of the method, apparatuses, and non-transitory computer-readable medium described herein may further include operations, features, means, or instructions for transmitting, to the candidate cell of the one or more candidate cells, the random access channel message using a periodic, semi-persistent, or aperiodic transmission scheme.

In some examples of the method, apparatuses, and non-transitory computer-readable medium described herein, the random access channel message may be associated with time advance measurement for the candidate cell of the one or more candidate cells.

In some examples of the method, apparatuses, and non-transitory computer-readable medium described herein, the first quantity of candidate cells includes serving cells configured for uplink, downlink, or both.

In some examples of the method, apparatuses, and non-transitory computer-readable medium described herein, the first quantity of candidate cells includes serving cells with a same center frequency as at least one candidate cell supported by the UE.

In some examples of the method, apparatuses, and non-transitory computer-readable medium described herein, the first quantity of candidate cells may be associated with a same band or a same band combination.

In some examples of the method, apparatuses, and non-transitory computer-readable medium described herein, the first quantity of candidate cells include candidate cells used for downlink synchronization maintenance.

A method for wireless communications is described. The method may include receiving a capability message indicating a first quantity of candidate cells supported by a UE for a first type of mobility procedure, transmitting, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure, and transmitting a downlink control channel order that instructs the UE to transmit a random access channel message to a candidate cell of the one or more candidate cells in accordance with the first type of mobility procedure.

An apparatus for wireless communications is described. The apparatus may include a processor, memory coupled with the processor, and instructions stored in the memory. The instructions may be executable by the processor to cause the apparatus to receive a capability message indicating a first quantity of candidate cells supported by a UE for a first type of mobility procedure, transmit, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure, and transmit a downlink control channel order that instructs the UE to transmit a random access channel message to a candidate cell of the one or more candidate cells in accordance with the first type of mobility procedure.

Another apparatus for wireless communications is described. The apparatus may include means for receiving a capability message indicating a first quantity of candidate cells supported by a UE for a first type of mobility procedure, means for transmitting, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure, and means for transmitting a downlink control channel order that instructs the UE to transmit a random access channel message to a candidate cell of the one or more candidate cells in accordance with the first type of mobility procedure.

A non-transitory computer-readable medium storing code for wireless communications is described. The code may include instructions executable by a processor to receive a capability message indicating a first quantity of candidate cells supported by a UE for a first type of mobility procedure, transmit, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure, and transmit a downlink control channel order that instructs the UE to transmit a random access channel message to a candidate cell of the one or more candidate cells in accordance with the first type of mobility procedure.

In some examples of the method, apparatuses, and non-transitory computer-readable medium described herein, receiving the capability message may include operations, features, means, or instructions for receiving, as part of the capability message, an indication of a threshold quantity of bands supported by the UE for transmission of the random access channel message.

In some examples of the method, apparatuses, and non-transitory computer-readable medium described herein, the indication includes a list of bands supported by the UE for transmission of the random access channel message and the indication indicates whether each band of the list of bands supports uplink transmission, downlink reception, or both.

In some examples of the method, apparatuses, and non-transitory computer-readable medium described herein, receiving the capability message may include operations, features, means, or instructions for receiving, as part of the capability message, an indication of a set of guard periods, where each guard period of the set of guard periods includes a respective duration between receiving the downlink control channel order and the UE transmitting the random access channel message.

In some examples of the method, apparatuses, and non-transitory computer-readable medium described herein, a first guard period of the set of guard periods may be associated with candidate cells included in the one or more candidate cells indicated by the control message and a second guard period of the set of guard periods may be associated with candidate cells excluded from the one or more candidate cells indicated by the control message, the first guard period being less than the second guard period.

In some examples of the method, apparatuses, and non-transitory computer-readable medium described herein, a third guard period of the set of guard periods may be associated with candidate cells associated with a same band as a current serving cell of the UE and a fourth guard period of the set of guard periods may be associated with candidate cells associated with a different band than the current serving cell, the third guard period being less than the fourth guard period.

In some examples of the method, apparatuses, and non-transitory computer-readable medium described herein, each guard period of the set of guard periods includes a single latency value indicative of the respective duration or a set of latency values indicative of the respective duration.

In some examples of the method, apparatuses, and non-transitory computer-readable medium described herein, each guard period of the set of guard periods may be associated with a respective candidate cell supported by the UE, a respective candidate cell group supported by the UE, or both.

In some examples of the method, apparatuses, and non-transitory computer-readable medium described herein, transmitting the control message may include operations, features, means, or instructions for transmitting a RRC message, a MAC-CE, or DCI.

In some examples of the method, apparatuses, and non-transitory computer-readable medium described herein, the second quantity of candidate cells may be less than or equal to the first quantity of candidate cells.

In some examples of the method, apparatuses, and non-transitory computer-readable medium described herein, the first type of mobility procedure may be a L1 mobility procedure or a L2 mobility procedure.

### BRIEF DESCRIPTION OF THE DRAWINGS

FIG. 1 illustrates an example of a wireless communications system that supports timing advanced measurement for candidate cells in accordance with one or more aspects of the present disclosure.

FIG. 2 illustrates an example of a wireless communications system that supports timing advanced measurement for candidate cells in accordance with one or more aspects of the present disclosure.

FIGS. 3A and 3B each illustrate an example of a cell configuration diagram that supports timing advanced measurement for candidate cells in accordance with one or more aspects of the present disclosure.

FIG. 4 illustrates an example of a process flow that supports timing advanced measurement for candidate cells in accordance with one or more aspects of the present disclosure.

FIGS. 5 and 6 illustrate block diagrams of devices that support timing advanced measurement for candidate cells in accordance with one or more aspects of the present disclosure.

FIG. 7 illustrates a block diagram of a communications manager that supports timing advanced measurement for candidate cells in accordance with one or more aspects of the present disclosure.

FIG. 8 illustrates a diagram of a system including a device that supports timing advanced measurement for candidate cells in accordance with one or more aspects of the present disclosure.

FIGS. 9 and 10 illustrate block diagrams of devices that support timing advanced measurement for candidate cells in accordance with one or more aspects of the present disclosure.

FIG. 11 illustrates a block diagram of a communications manager that supports timing advanced measurement for candidate cells in accordance with one or more aspects of the present disclosure.

FIG. 12 illustrates a diagram of a system including a device that supports timing advanced measurement for candidate cells in accordance with one or more aspects of the present disclosure.

FIGS. 13 through 16 illustrate flowcharts showing methods that support timing advanced measurement for candidate cells in accordance with one or more aspects of the present disclosure.

### DETAILED DESCRIPTION

In some examples of wireless communications, a user equipment (UE) may perform handover from a source cell (e.g., a primary cell (PCell), primary secondary cell (PSCell), or secondary cell (SCell)) to a target cell. For example, as the UE moves, the PCell may be reselected or updated among a set of preconfigured candidate PCells. As such, the UE may handover to a target cell (e.g., candidate PCell, PSCell, or SCell) using layer 1 (L1) or layer 2 (L2) signaling (e.g., as part of an L1/L2 triggered mobility (LTM) procedure). In some examples, the UE may receive from the source cell (e.g., a current serving cell) a physical downlink channel (PDCCH) order indicating for or instructing the UE to transmit a physical random access channel (PRACH) message to the target cell as part of handover to the target cell. In some examples, the target cell may be candidate cell that is not configured as a serving cell (e.g., not configured to support uplink communications, downlink communications, or both with the UE). As such, the UE may generate an radio frequency (RF) script to configure transmission chain parameters such that the target cell may communicate with the UE. However, generating and loading the RF script may increase the time between receiving the PDCCH order from the source cell and transmitting the PRACH message to the target cell, which may increase latency. Additionally, storing the RF script for all candidate cells or maintaining RF scripts for a set of candidate cells may reduce an available memory located at the UE.

The UE and the cells may reduce the latency associated with preparing the PRACH message by operating in accordance with the techniques described herein. For instance, the UE may transmit a capability message that may indicate a quantity of candidate cells the UE may support. In response to the capability message, the UE may receive a control message from the source cell indicating a set of candidate cells for the UE to prepare for a potential handover. The UE may proceed to preemptively (e.g., before a PDCCH order for handover) generate respective RF scripts for each cell of the set of indicated cells. As such, based on receiving a PDCCH order, the UE may identify which candidate cell is the target cell and use the pre-generated RF script associated with the candidate cell to transmit the PRACH message. Additionally, the UE may transmit in the capability message an indication of a quantity of frequency bands the UE may support. The indication may indicate a quantity of bands, a list of bands that may support uplink and downlink communications with candidate cells, or both.

Additionally, the UE may transmit in the capability message an indication of a time duration (e.g., a guard period) associated with preparing the PRACH message, based on different conditions (e.g., whether the source cell indicates for the UE to preemptively generate an RF script for the target cell, whether the source cell and target cell are on a same frequency band, etc.).

Aspects of the disclosure are initially described in the context of wireless communications systems, cell configuration diagrams, and a process flow. Aspects of the disclosure are further illustrated by and described with reference to apparatus diagrams, system diagrams, and flowcharts that relate to timing advanced measurement for candidate cells.

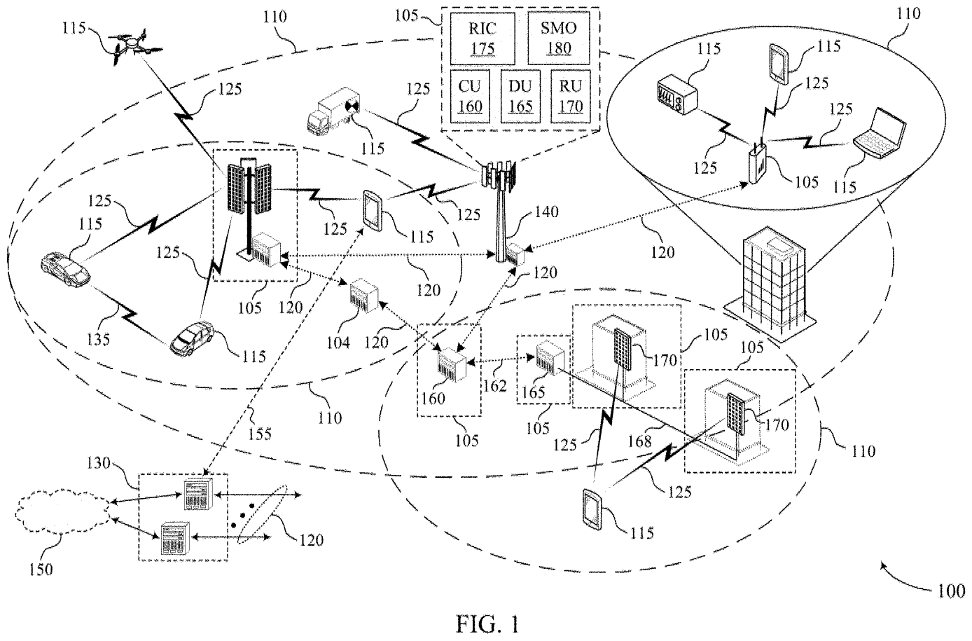

FIG. 1 illustrates an example of a wireless communications system 100 that supports timing advanced measurement for candidate cells in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), L2) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as L2 (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support timing advanced measurement for candidate cells as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples of wireless communications system 100, a UE 115 may perform a handover procedure. For example, one or more network entities 105 may support one or more cells that the UE 115 may communicate with. In accordance with the handover procedure, the UE 115 may switch communications from a source cell (e.g., a PCell, PSCell, SCell) to a target cell (e.g., a target PCell, target PSCell, target SCell). For example, as the UE 115 moves, the PCell may be reselected or updated among a set of preconfigured candidate PCells. As such, the UE 115 may handover to a preconfigured PCell using an LTM procedure). In some examples, the UE 115 may receive from the source cell (e.g., a current serving cell) a PDCCH order indicating for the UE 115 to transmit a PRACH message to the target cell. In some examples, the target cell may be a candidate cell that is not configured as a serving cell (e.g., not configured to support uplink communications with the UE 115). As such, the UE 115 may generate an RF script to configure transmission chain parameters such that the target cell may communicate with the UE 115.

The UE 115 and the cells may reduce the latency associated with preparing the PRACH message by operating in accordance with the techniques described herein. For instance, the UE 115 may transmit a capability message that may indicate a quantity of candidate cells the UE 115 may support. In response to the capability message, the UE 115 may receive a control message from the source cell indicating a set of candidate cells for the UE 115 to prepare for a potential handover. The UE 115 may proceed to preemptively generate respective RF scripts for each cell of the set of indicated cells. As such, based on receiving a PDCCH order, the UE 115 may identify which candidate cell is the target cell and use the pre-generated RF script associated with the candidate cell to transmit the PRACH message. Additionally, the UE 115 may transmit in the capability message an indication of a quantity of frequency bands the UE 115 may support. The indication may indicate a quantity of bands, a list of bands that may support uplink and downlink communications with candidate cells, or both. Additionally, the UE 115 may transmit in the capability message an indication of a time duration (e.g., a guard period) associated with preparing the PRACH message, based on different conditions (e.g., whether the source cell indicates for the UE 115 to preemptively generate an RF script for the target cell, whether the source cell and target cell are on a same frequency band, etc.).

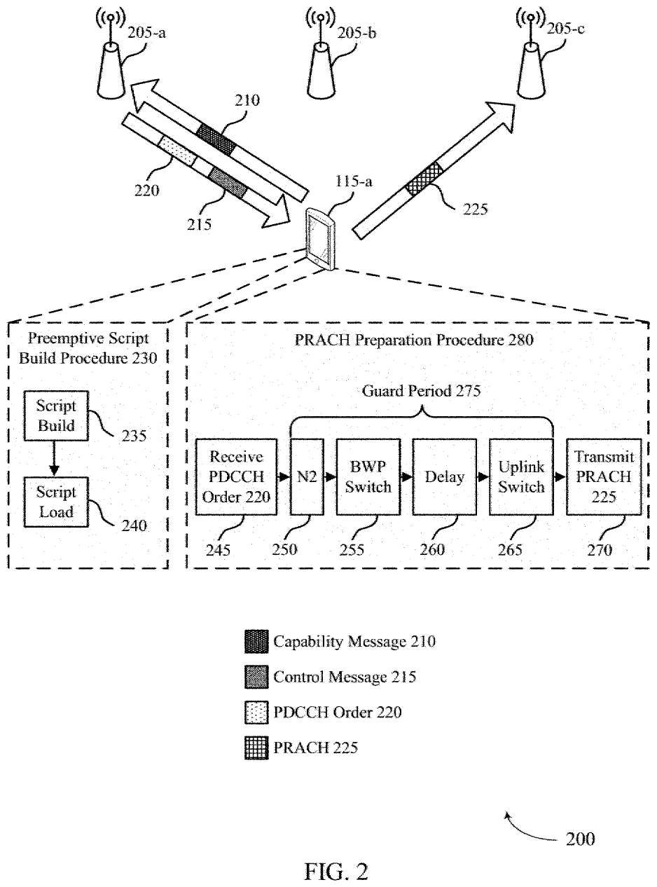

FIG. 2 illustrates an example of a wireless communications system 200 that supports timing advanced measurement for candidate cells in accordance with one or more aspects of the present disclosure. In some examples, the wireless communications system 200 may implement or be implemented by aspects of the wireless communications system 100. For example, the wireless communications system 200 may be implemented by a UE 115-a which may be an example of a UE 115, with reference to FIG. 1. Additionally, the wireless communications system 200 may be implemented by one or more network entities 105 which may support cells 205-a, 205-b, and 205-c. That is, the cells 205-a, 205-b, and 205-c may be supported by a same network entity 105, respective network entities 105, or a combination thereof. In the example of FIG. 2, the network entities 105 supporting the cells 205 may be an example of a CU 160, a DU 165, an RU 170, a base station 140, an IAB node 104, or one or more other network nodes as described herein with reference to FIG. 1. In some aspects, the UE 115-a may transmit UE 115-a capability information to a current source cell 205 to reduce latency in performing a handover procedure to a target cell 205.

As illustrated in FIG. 2, the UE 115-a may communicate with cell 205-a. In some examples, cell 205-a may be configured as a primary cell (e.g., PCell). The PCell may refer to a source cell 205 over which a UE 115-a performs an initial connection with the associated network, or a connection re-establishment with the network, and is the cell 205 with which the UE 115-a performs a majority of communications with the network. In some cases (e.g., if UE 115-a is mobile or if network conditions change), communication quality may be increased by changing the PCell to another cell 205. As such, the UE 115-a may transition the PCell from cell 205-a to a candidate cell 205 (e.g., cell 205-b or cell 205-c). Such techniques may be referred to as an LTM procedure. For instance, as the UE 115-a moves, the PCell may be reselected or updated among a set of pre-configured candidate PCells (e.g., cells 205-b and 205-c) based on the UE 115-a performing L1 (or L2) measurements with each of the pre-configured candidate PCells.

In some cases, the UE 115-a may transmit a PRACH 225 to a candidate cell 205 as part of the LTM procedure. In some examples, the UE 115-a may transmit the PRACH 225 to the given candidate cell 205 (e.g., cell 205-c) for performing timing advance measurements before the candidate cell 205 is selected as the next serving cell 205. By transmitting the PRACH 225 before the candidate cell 205 is selected as the next serving cell 205, the UE 115-a may reduce timing advance acquisition time associated with performing the LTM procedure. Alternatively, the PRACH 225 may be a sounding reference signal (SRS).

In some examples, transmission of the PRACH 225 may be triggered by the current source cell 205. For instance, cell 205-a may transmit a PDCCH order 220 to the UE 115-a. In some examples, the PDCCH order 220 may include one or more of downlink control information (DCI), a random access channel (RACH) resource configuration, or a random access response (RAR) transmission mechanism, among other examples. The DCI of the PDCCH order 220 may trigger the PRACH 225 or the SRS for periodic transmission, semi-persistent transmission, or aperiodic transmission.

Based on receiving the PDCCH order 220, the UE 115-a may perform a PRACH preparation procedure 280. At 245, the UE 115-a may receive the PDCCH order 220. As such, the UE 115-a may perform one or more operations to generate the PRACH 225 to transmit to cell 205-c. At 250, the UE 115-a may prepare a physical uplink shared channel (PUSCH) associated with preparation procedure time of N2 (e.g., N_T,2). At 255, the UE 115-a may perform a BWP switch (e.g., Delta_BWPSwitching). The UE 115-a may determine to perform the BWP switch if the current active uplink BWP is not configured with a RACH occasion (RO). At 260, the UE 115-a may operate in accordance with a delay (e.g., Delta_delay). In some examples, the delay may be a fixed duration associated with the frequency range the UE 115-a operates in (e.g., for frequency range 1 (FR1), Delta_delay=0.5 ms and for frequency range 2 (FR2) Delta_delay=0.25 ms). At 265, the UE 115-a may perform an uplink switch in which the UE 115-a may wait a duration of time (e.g., T_switch) between a most recent uplink transmission and transmitting the PRACH 225. At 270, the UE 115-a may transmit the PRACH 225 to the cell 205-c. Alternative examples of PRACH preparation procedure 280 may be implemented, where some steps are performed in a different order than described or are not performed at all. In some cases, steps may include additional features not mentioned, or further steps may be added.

As illustrated in FIG. 2, the PRACH preparation procedure 280 may be associated with guard period 275, which may be a duration of time between reception of the PDCCH and transmission of the PRACH 225. In some cases, the candidate cell 205 indicated in the PDCCH order 220 may not be configured as a serving cell 205 supporting uplink communications (e.g., may not be associated with an uplink component carrier (CC)). In such cases, the UE 115-a may generate an RF script for the candidate cell 205 and store the RF script in an on-chip memory of the UE 115-a before the UE 115-a may transmit the PRACH 225. The RF script may be used to configure transmission chain parameters to configure the candidate cell 205 for uplink (e.g., a gain stage setting, an RF filter configuration, an envelope tracking configuration, and an RF switching configuration). In some examples, the RF script may be a delta RF script (e.g., include a set of parameters that indicate a change in the chain parameters relative to a current RF script). RF script building and loading may occur during the PRACH preparation procedure 280 (e.g., RF script building may be approximately 5 ms and RF script loading from external memory may be approximately 2 ms), which may increase latency between the PDCCH order 220 and transmission of the PRACH 225. As such, RF script building and loading may increase the guard period 275, which may increase the latency associated with preparing the PRACH 225. Additionally, storing RF scripts may reduce on-chip memory space at the UE 115-a.

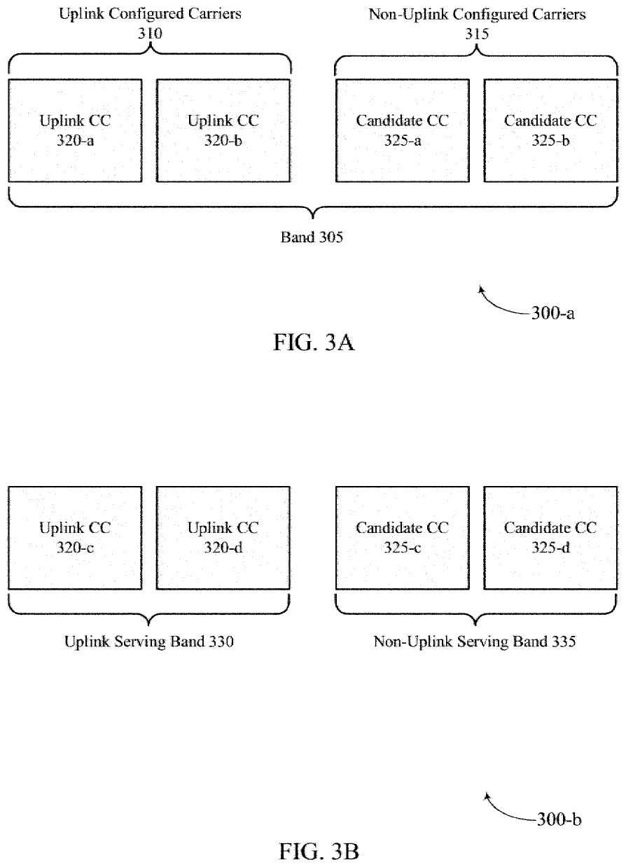

The UE 115-a and the cells 205 may reduce latency associated with the PRACH preparation procedure 280 by operating in accordance with the techniques described herein. For example, the UE 115-a may transmit, to the current source cell 205 (e.g., cell 205-a), a capability message 210 that may indicate a threshold quantity of candidate cells 205 the UE 115-a may support. Further discussion of how the UE 115-a determines a value for the threshold quantity of candidate cells 205 is described herein, including with reference to FIG. 3A.

To address the additional latency due to RF script building and loading, the cell 205-a may transmit a control message 215 that indicates a set cells 205 for the UE 115-a to prepare for a potential LTM procedure (e.g., a set of cells 205 for potential uplink transmission and downlink reception). In some examples, the quantity of cells 205 indicated in the control message may be less than or equal to the threshold quantity of candidate cells 205 indicated by the UE 115-a in the capability message 210. In some examples, the control message 215 may be an example of RRC, a medium access control-control element (MAC-CE), or DCI.

Based on receiving the control message 215, the UE 115-a may perform a preemptive script build procedure 230. For example, the control message 215 may indicate for the UE 115-a to preemptively prepare RF scripts for cell 205-b and cell 205-c. As such, at 235 the UE 115-a may build an RF script for cell 205-b, and at 240, the UE 115-a may load the RF script for cell 205-b. The UE 115-a may perform the preemptive script build procedure 230 for each of the set of cells 205 indicated in the control message 215. For instance, subsequent to performing the preemptive script build procedure 230 for cell 205-b, the UE 115-a may perform the preemptive script build procedure 230 for cell 205-c. In some examples, the control message 215 may indicate an application time (e.g., a duration of time allotted for the UE 115-a to perform the preemptive script build procedure 230 for each of the set of cells 205 indicated in the control message 215). As such, after the application time expires, cell 205-a may assume that the UE 115-a has built and loaded respective RF scripts for each of the candidate cells 205 indicated in the control message 215.

As such, at a time after the allotted application time expires, the cell 205-a may transmit the PDCCH order 220 to the UE 115-a. In accordance with FIG. 2, the PDCCH order 220 may indicate for the UE 115-a to prepare a PRACH 225 for the cell 205-c. Based on pre-building and loading the RF script for cell 205-c, the guard period 275 for PRACH preparation procedure 280 may be reduced, which may decrease the time between receiving the PDCCH order 220 and transmitting the PRACH 225.

In some cases, one or more candidate cells 205 may be on a frequency band different than any serving cell 205 supporting uplink. For example, the source cell 205 (e.g., cell 205-a) may be associated with a first band supporting uplink and cell 205-b, cell 205-c, or both may be associated with a second band that does not support uplink. As such, the UE 115-a may transmit as part of the capability message 210 an indication of a threshold quantity of bands that the UE 115-a may support. Further discussion of how the UE 115-a determines a value for the threshold quantity of bands is described herein, including with reference to FIG. 3B.

As described herein, the duration of the guard period 275 associated with the PRACH preparation procedure 280 may be based on different network conditions. For example, if a candidate cell 205 is not configured as an uplink serving cell 205 and the source cell 205 does not indicate to the UE 115-a to perform the preemptive script build procedure 230, then the guard period 275 may be of a first duration that includes latency associated with performing the script build and the script load. If a candidate cell 205 is not an uplink serving candidate cell 205 is not configured as an uplink serving cell 205 and the source cell 205 does indicate to the UE 115-a to perform the preemptive script build procedure 230, then the guard period 275 may be of a second duration less than the first duration, based on the UE 115-a preemptively performing the script build and script load. Additionally, or alternatively, if the candidate cell 205 is configured in a band that does not include an uplink serving cell 205, then the guard period 275 may be of third duration associated with additional latency for the UE 115-a to switch a transmission chain to a band that includes an uplink serving cell 205. While FIG. 2 discusses three network conditions that are associated with three respective guard periods 275, it is understood that there may be any quantity of network conditions associated with any quantity of respective guard periods 275.

As such, the UE 115-a may transmit capability information indicating one or more respective guard periods 275 associated with respective network conditions. As described herein, the capability may indicate different guard periods 275 for different cases (e.g., in accordance with the network conditions associated with the candidate cell 205 indicated in the PDCCH order 220). Additionally, or alternatively, the capability may be reported for each candidate cell 205 associated with the UE 115-a, each candidate cell 205 indicated in the control message 215, on a per candidate cell group basis, or a combination thereof. In some examples, a cell group may include candidate cells 205 in a same band as the current source cell 205. In some examples, a cell group may include candidate cells 205 in a band that does not include a current uplink serving cell 205. The capability may indicate the duration associated with a given guard period 275 or may indicate individual time values associated with the given guard period (e.g., N_T,2, Delta_BWPSwitching, Delta_delay, T_switch, etc.). In some examples, the capability indicating the one or more guard periods may be included in the capability message 210. Additionally, or alternatively, the capability indicating the one or more guard periods may be included in a separate message (e.g., RRC, MAC-CE, or DCI).

Additionally, or alternatively, the capability indicating the one or more guard periods may be pre-configured at the UE 115-a and the cells 205.

FIGS. 3A and 3B each illustrate an example of a cell configuration diagram 300 that supports timing advanced measurement for candidate cells in accordance with one or more aspects of the present disclosure. In some examples, the cell configuration diagrams 300 may implement or be implemented by aspects of the wireless communications system 100 and 200. For example, the cell configuration diagrams 300 may include a set of CCs that may be associated with a set of cells 205, where the cells 205 may be examples of cells 205, with reference to FIG. 2. As such the UE 115-a and the cells 205 may communicate the messages described in FIG. 2 in accordance with the cell configuration diagrams 300.

As illustrated in FIG. 3A, a band 305 may include one or more sets of carriers. For example, the cell configuration diagram 300-a may include a set of uplink configured carriers 310 (e.g., uplink CC 320-a and uplink CC 320-b) and may include non-uplink configured carriers 315 (e.g., candidate CC 325-a and candidate CC 325-b). As such, candidate cells 205 associated with the uplink configured carriers 310 may be configured for uplink and candidate cells 205 associated with the non-uplink configured carriers 315 may not be configured for uplink. In some aspects, the uplink may at least include the PRACH or SRS transmission, which may be periodic, semi-persistent, or aperiodic (e.g., triggered by a DCI). In some other aspects, the uplink may be at least for uplink timing advance (TA) measurement for corresponding candidate cells 205. As described with reference to FIG. 2, the UE 115-a may transmit in the capability message 210 a threshold quantity of candidate cells 205 the UE 115-a may support. The UE 115-a may determine the value of the threshold quantity in accordance with the techniques described herein.

In some examples, the threshold quantity of candidate cells 205 may include or exclude serving cells 205 that support uplink, serving cells 205 that support downlink, or serving cells 205 that support uplink and downlink. Additionally, or alternatively, the threshold quantity of candidate cells 205 may include or exclude each serving cell 205 with a same center frequency or bandwidth with at least one candidate cell 205. Additionally, or alternatively, the UE 115-a may configure respective threshold quantities of candidate cells 205 per band, per band combination, or per UE. Additionally, or alternatively, the threshold quantity of candidate cells 205 may be the same or different as the cells with downlink timing synchronization maintenance.

In some examples, the UE 115-a may report a threshold quantity (or maximum number) of supported candidate cells 205 that can be indicated for PDCCH-order based uplink TA measurement using PRACH. In some aspects, the threshold quantity of supported candidate cells may exclude uplink serving cells (e.g., configured with PUCCH and/or PUSCH transmissions). In some aspects, the threshold quantity of supported candidate cells may include inter-frequency candidate cells which have a different cell bandwidth, a different center frequency and/or downlink or uplink subcarrier spacing in the BWP, a different center frequency and/or subcarrier spacing for SSB or CSI-RS from that of the serving cell.

As illustrated in cell configuration diagram 300-b, one or more uplink CCs 320 (e.g., uplink CC 320-c and uplink CC 320-d) may be associated with an uplink serving band 330 and one or more candidate CCs 325 (e.g., candidate CC 325-c and candidate CC 325-d) may be associated with a non-uplink serving band 335. As described with reference to FIG. 2, the UE 115-a may transmit in the capability message 210 a threshold quantity of bands the UE 115-a may support. In some examples, the indication may indicate a quantity of bands, a list of bands that may support uplink and/or downlink communications with candidate cells 205, or both. As such, the source cell 205 may receive the indication of the threshold quantity of bands and identify whether uplink, downlink, or both are configurable or feasible for candidate cells 205 on each of the bands. In some examples, the quantity of bands may include or exclude bands configured with serving cells 205 supporting uplink, serving cells 205 supporting downlink, or serving cells 205 supporting both uplink and downlink. The indication of the threshold quantity of bands may allow the source cell 205 with configuration to transmit a PDCCH order 220 for candidate cells 205 associated with non-uplink serving bands 335, where the non-uplink serving bands 335 may not include serving cells 205 supporting uplink or downlink. Without this capability report or by default, the uplink transmission and/or downlink reception may be not allowed on any band without any serving cell supporting uplink and/or downlink. For example, without this capability report or by default, the UE may be not expected to be indicated with PDCCH order 220 based RACH for candidate cells 205, where the candidate cells 205 may include the candidate cells 205 on a band without an uplink serving cell, and/or the candidate cells 205 that are not uplink serving cell(s). Additionally, or alternatively, the UE 115-a may configure respective threshold quantities of bands that may be reported per band, per band combination, or per UE.

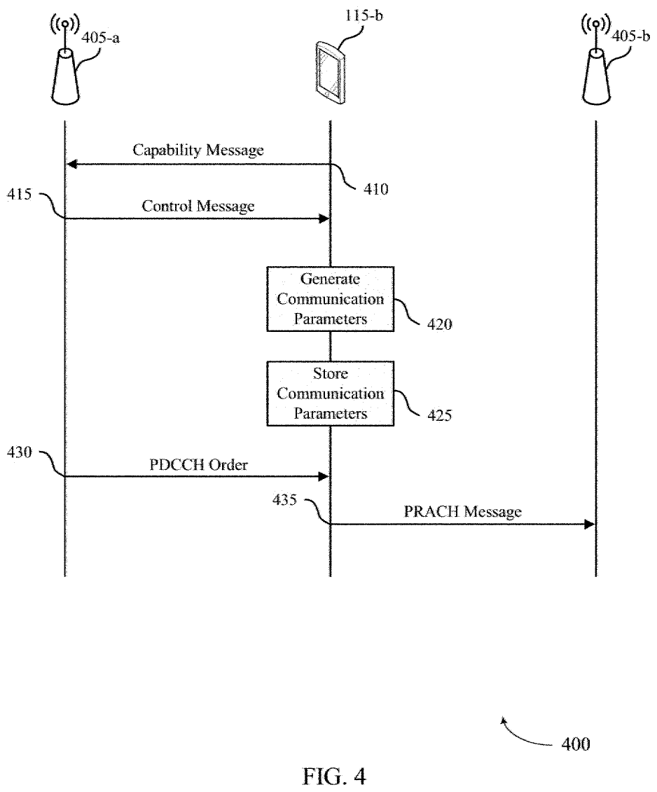

FIG. 4 illustrates an example of a process flow 400 that supports timing advanced measurement for candidate cells in accordance with one or more aspects of the present disclosure. In some examples, process flow 400 may implement aspects of wireless communications system 100, wireless communications system 200, and cell configuration diagrams 300. Process flow 400 includes a UE 115-b and cells 405-a and 405-b, which may be respective examples of a UE 115 and cells 205, as described with reference to FIGS. 1 and 2. Alternative examples of the following may be implemented, where some steps are performed in a different order than described or are not performed at all. In some cases, steps may include additional features not mentioned below, or further steps may be added. In addition, while process flow 400 shows processes between a single UE 115 and two cells 405, it should be understood that these processes may occur between any quantity of network devices and network device types.

At 410, the UE 115-b may transmit to the cell 405-a (e.g., the current source cell), a capability message indicating a first quantity of candidate cells supported by the UE 115-b for a first type of mobility procedure (e.g., capability message 210, with reference to FIG. 2). In some examples, the first type of mobility procedure may be an LTM procedure.

In some examples, the first quantity of candidate cells may include serving cells configured for uplink, downlink, or both. Additionally, or alternatively, the first quantity of candidate cells may include serving cells with a same center frequency as at least one candidate cell supported by the UE 115-b. Additionally, or alternatively, the first quantity of candidate cells may be associated with a same band or a same band combination. Additionally, or alternatively, the first quantity of candidate cells may include candidate cells used for downlink synchronization maintenance.

Additionally, or alternatively, the capability message may include indication of a threshold quantity of bands supported by the UE 115-b for transmission of a PRACH message (e.g., PRACH 225, with reference to FIG. 2). For example, the indication may include a list of bands supported by the UE 115-b for transmission of the PRACH message. In some examples, the indication may indicate whether each band of the list of bands supports uplink transmission, downlink reception, or both.

In some examples, the UE 115-b may transmit an indication of a set of guard periods, where each guard period of the set of guard periods includes a respective duration between receiving a PDCCH order from cell 405-a and the UE 115-b transmitting the PRACH message. The indication of the set of guard periods may be included in the capability message, included in a different capability message, or pre-configured at the UE 115-b and each of the cells 405. In some examples, each guard period of the set of guard periods may include a single latency value indicative of the respective duration or a set of latency values indicative of the respective duration. In some examples, each guard period of the set of guard periods may be associated with a respective candidate cell supported by the UE 115-b, a respective candidate cell group supported by the UE 115-b, or both. The capability may be reported for all candidate cells, per candidate cell, or per candidate cell group. In some aspect, the single latency value indicative of the respective duration or the set of latency values indicative of the respective duration may be a fixed value without a UE capability.

In some examples, a first guard period of the set of guard periods may be associated with candidate cells included in the one or more candidate cells indicated by a control message transmitted by the cell 405-a, at 415, and a second guard period of the set of guard periods may be associated with candidate cells excluded from the one or more candidate cells indicated by the control message, where the first guard period may be less than the second guard period. In some examples, a third guard period of the set of guard periods may be associated with candidate cells associated with a same band as the current serving cell of the UE 115-b (e.g., cell 405-a) and a fourth guard period of the set of guard periods associated with candidate cells associated with a different band than the current serving cell, where the third guard period may be less than the fourth guard period.

In some aspects, the transmission of a PRACH in a band may interrupt other bands. The UE 115-b may report per a band combination, the corresponding interrupted bands for a given band switch pair due to a given PRACH transmission in a band. As a first option, the UE may report per band combination a list of interrupted bands for a given PRACH transmission in a band. As a second option, the UE may report per band combination a list of interrupted bands per target and source band for the band switch pair due to PRACH transmission. For example, a band combination may have 3 bands (e.g., band A, B, C), where the PRACH is transmitted on band A. As an example of the first option, the UE may report a list of interrupted bands (e.g., band A and B). As an example of the second option, the UE may report for the case that a PRACH is transmitted in band A and a PUSCH is transmitted in band B, the interrupted bands are band A and B, or band A, B, and C. In another example of the second option, the UE may report for the case that a PRACH is transmitted in band A and a PUSCH is transmitted in band C, the interrupted bands are band A and C, or band A, B, and C.

At 415, the UE 115-b may receive from cell 405-a in response to the capability message, the control message (e.g., control message 215, with reference to FIG. 2) indicating one or more candidate cells that correspond to a second quantity of candidate cells. In some examples, the second quantity of candidate cells may be in accordance with the first quantity of candidate cells supported by the UE 115-b. For instance, the second quantity of candidate cells may be less than or equal to the first quantity of candidate cells. Additionally, or alternatively, the one or more candidate cells may be candidates for the first type of mobility procedure. In some examples, at least when the number of configured candidate cells exceeds the UE capability, to minimize PDCCH-order triggering latency, the UE 115-b may be indicated by a control message which candidate cells to be potentially indicated for PDCCH-order based TA measurement. The control message may be an RRC message, a MAC-CE, or a DCI.

At 420, the UE 115-b may generate a respective set of communication parameters for each candidate cell of the one or more candidate cells indicated in the control message. In some examples, the UE 115-b may generate the respective sets of communication parameters before receiving a PDCCH order, at 430. In some examples, the control message may include an indication of a time duration to generate each of the respective sets of communication parameters. The indication may be associated with an application time, e.g., the indication may take effect after a time duration (e.g., a number of milli-seconds or slots from the end of the indication or the end of confirmation for the indication). As such, the UE 115-b may generate the respective set of communication parameters for each candidate cell of the one or more candidate cells in accordance with the application time, and afterward, there is no additional latency for generating the respective set of communication parameters for each candidate cell when triggered with PRACH.

At 425, the UE 115-b may store (e.g., at an on-chip memory of the UE 115-b), each respective set of communication parameters. In some examples, each respective set of communication parameters may include a gain stage setting, an RF filter configuration, an envelope tracking configuration, a radio frequency switch configuration, or a combination thereof.

At 430, the UE 115-b may receive a PDCCH order that instructs the UE 115-b to transmit a PRACH message to a candidate cell of the one or more candidate cells in accordance with the first type of mobility procedure. For example, the PDCCH order may instruct the UE 115-b to transmit a PRACH message to the cell 405-b.

At 435, the UE 115-b may transmit the PRACH message to the cell 405-b in accordance with the respective set of communication parameters associated with the 405-b that the UE 115-b generated and stored at 420 and 425 respectively. In some examples, the UE 115-b may transmit the PRACH to cell 405-b using a periodic, semi-persistent, or aperiodic transmission scheme. In some examples, the PRACH message may be associated with a timing advance measurement of the cell 405-b.

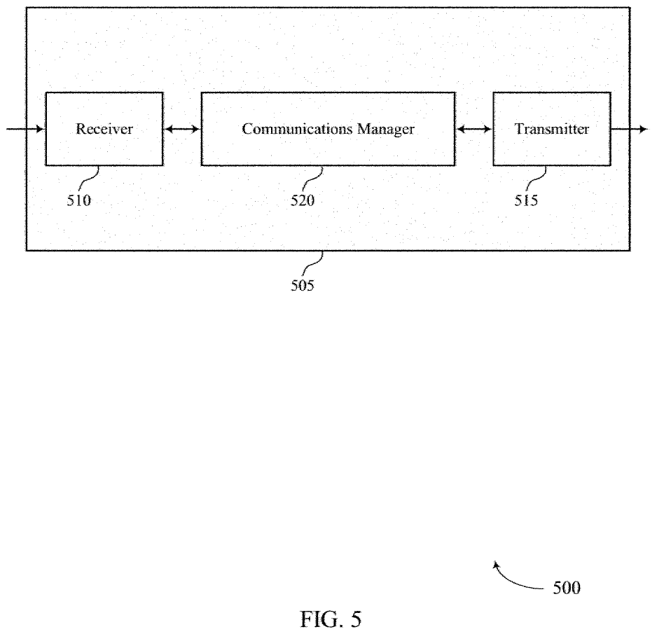

FIG. 5 illustrates a block diagram 500 of a device 505 that supports timing advanced measurement for candidate cells in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to timing advanced measurement for candidate cells). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to timing advanced measurement for candidate cells). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of timing advanced measurement for candidate cells as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 may be configured as or otherwise support a means for transmitting a capability message indicating a first quantity of candidate cells supported by the UE for a first type of mobility procedure. The communications manager 520 may be configured as or otherwise support a means for receiving, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure. The communications manager 520 may be configured as or otherwise support a means for receiving a downlink control channel order that instructs the UE to transmit a random access channel message to a candidate cell of the one or more candidate cells in accordance with the first type of mobility procedure.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced latency for handover between cells, reduced processing, reduced power consumption, and a more efficient utilization of communication resources.

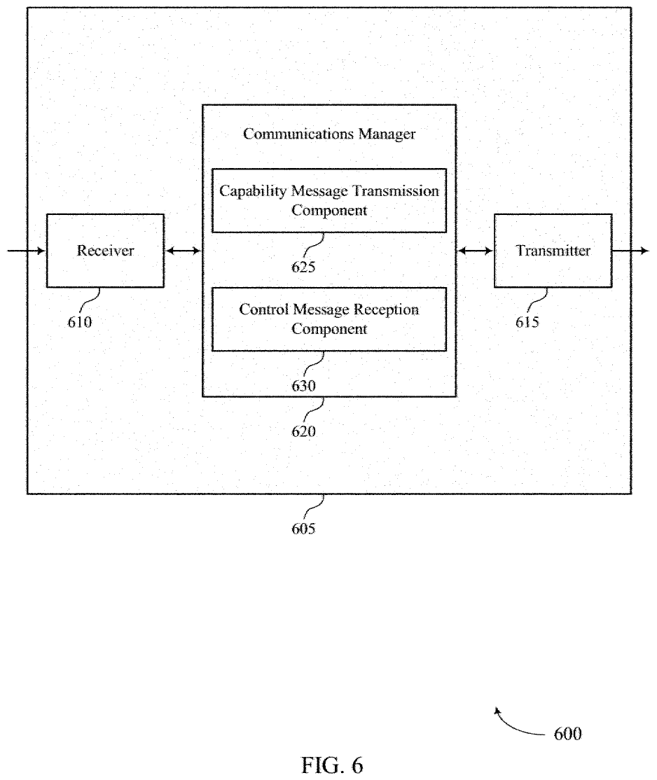

FIG. 6 illustrates a block diagram 600 of a device 605 that supports timing advanced measurement for candidate cells in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to timing advanced measurement for candidate cells). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to timing advanced measurement for candidate cells). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of timing advanced measurement for candidate cells as described herein. For example, the communications manager 620 may include a capability message transmission component 625 a control message reception component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The capability message transmission component 625 may be configured as or otherwise support a means for transmitting a capability message indicating a first quantity of candidate cells supported by the UE for a first type of mobility procedure. The control message reception component 630 may be configured as or otherwise support a means for receiving, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure. The control message reception component 630 may be configured as or otherwise support a means for receiving a downlink control channel order that instructs the UE to transmit a random access channel message to a candidate cell of the one or more candidate cells in accordance with the first type of mobility procedure.

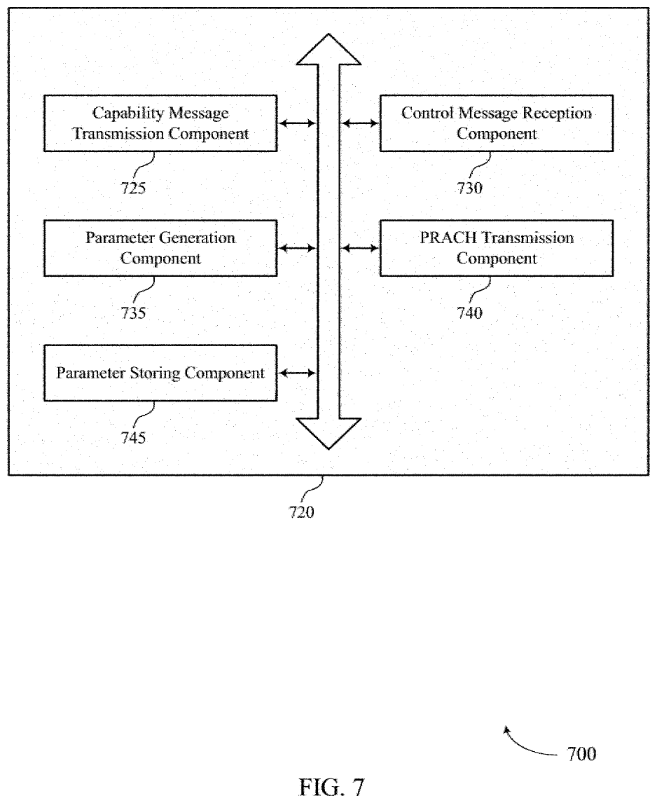

FIG. 7 illustrates a block diagram 700 of a communications manager 720 that supports timing advanced measurement for candidate cells in accordance with one or more aspects of the present disclosure. The communications manager 720 may be an example of aspects of a communications manager 520, a communications manager 620, or both, as described herein. The communications manager 720, or various components thereof, may be an example of means for performing various aspects of timing advanced measurement for candidate cells as described herein. For example, the communications manager 720 may include a capability message transmission component 725, a control message reception component 730, a parameter generation component 735, a PRACH transmission component 740, a parameter storing component 745, or any combination thereof. Each of these components may communicate, directly or indirectly, with one another (e.g., via one or more buses).

The communications manager 720 may support wireless communications in accordance with examples as disclosed herein. The capability message transmission component 725 may be configured as or otherwise support a means for transmitting a capability message indicating a first quantity of candidate cells supported by the UE for a first type of mobility procedure. The control message reception component 730 may be configured as or otherwise support a means for receiving, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure. In some examples, the control message reception component 730 may be configured as or otherwise support a means for receiving a downlink control channel order that instructs the UE to transmit a random access channel message to a candidate cell of the one or more candidate cells in accordance with the first type of mobility procedure.

In some examples, the parameter generation component 735 may be configured as or otherwise support a means for generating, before receiving the downlink control channel order, a respective set of communication parameters for each candidate cell of the one or more candidate cells. In some examples, the PRACH transmission component 740 may be configured as or otherwise support a means for transmitting the random access channel message to the candidate cell of the one or more candidate cells in accordance with the respective set of communication parameters associated with the candidate cell.

In some examples, to support receiving the control message, the control message reception component 730 may be configured as or otherwise support a means for receiving, as part of the control message, an indication of a time duration to generate each respective set of communication parameters, where generating the respective set of communication parameters for each candidate cell of the one or more candidate cells is based on the time duration.

In some examples, the parameter storing component 745 may be configured as or otherwise support a means for storing, at the UE, each respective set of communication parameters, where each respective set of communication parameters includes a gain stage setting, a radio frequency filter configuration, an envelope tracking configuration, a radio frequency switch configuration, or a combination thereof.

In some examples, to support transmitting the capability message, the capability message transmission component 725 may be configured as or otherwise support a means for transmitting, as part of the capability message, an indication of a threshold quantity of bands supported by the UE for transmission of the random access channel message.

In some examples, the indication includes a list of bands supported by the UE for transmission of the random access channel message. In some examples, the indication indicates whether each band of the list of bands supports uplink transmission, downlink reception, or both.

In some examples, to support transmitting the capability message, the capability message transmission component 725 may be configured as or otherwise support a means for transmitting, as part of the capability message, an indication of a set of guard periods, where each guard period of the set of guard periods includes a respective duration between receiving the downlink control channel order and the UE transmitting the random access channel message.

In some examples, a first guard period of the set of guard periods is associated with candidate cells included in the one or more candidate cells indicated by the control message and. In some examples, a second guard period of the set of guard periods is associated with candidate cells excluded from the one or more candidate cells indicated by the control message, the first guard period being less than the second guard period.

In some examples, a third guard period of the set of guard periods is associated with candidate cells associated with a same band as a current serving cell of the UE and. In some examples, a fourth guard period of the set of guard periods is associated with candidate cells associated with a different band than the current serving cell, the third guard period being less than the fourth guard period.

In some examples, each guard period of the set of guard periods includes a single latency value indicative of the respective duration or a set of latency values indicative of the respective duration.

In some examples, each guard period of the set of guard periods is associated with a respective candidate cell supported by the UE, a respective candidate cell group supported by the UE, or both.

In some examples, to support receiving the control message, the control message reception component 730 may be configured as or otherwise support a means for receiving a RRC message, a MAC-CE, or DCI.

In some examples, the second quantity of candidate cells is less than or equal to the first quantity of candidate cells.

In some examples, the first type of mobility procedure is a LI mobility procedure or a L2 mobility procedure.

In some examples, the PRACH transmission component 740 may be configured as or otherwise support a means for transmitting, to the candidate cell of the one or more candidate cells, the random access channel message using a periodic, semi-persistent, or aperiodic transmission scheme.

In some examples, the random access channel message is associated with time advance measurement for the candidate cell of the one or more candidate cells.

In some examples, the first quantity of candidate cells includes serving cells configured for uplink, downlink, or both.

In some examples, the first quantity of candidate cells includes serving cells with a same center frequency as at least one candidate cell supported by the UE.

In some examples, the first quantity of candidate cells are associated with a same band or a same band combination.

In some examples, the first quantity of candidate cells include candidate cells used for downlink synchronization maintenance.

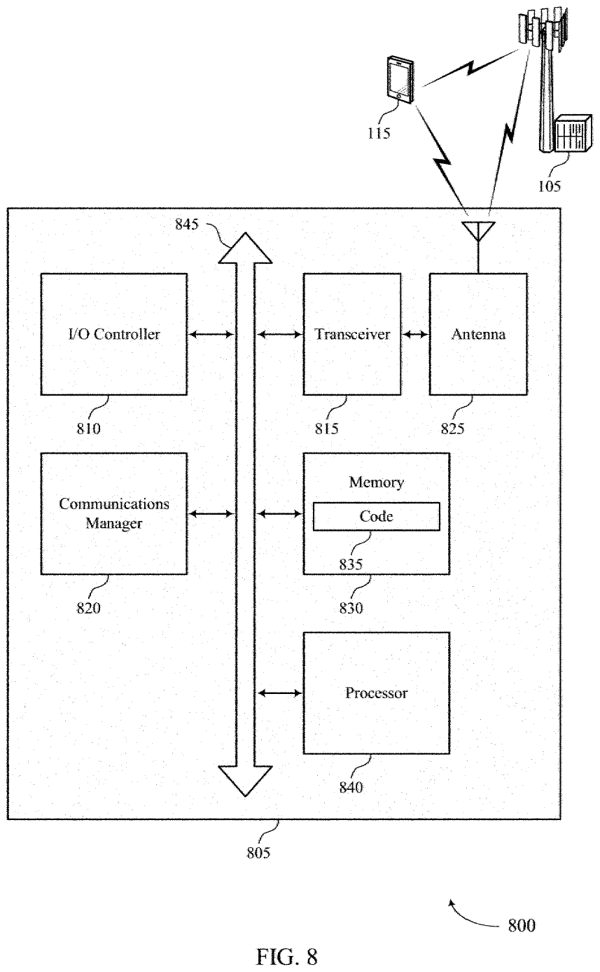

FIG. 8 illustrates a diagram of a system 800 including a device 805 that supports timing advanced measurement for candidate cells in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting timing advanced measurement for candidate cells). For example, the device 805 or a component of the device 805 may include a processor 840 and memory 830 coupled with or to the processor 840, the processor 840 and memory 830 configured to perform various functions described herein.

The communications manager 820 may support wireless communications in accordance with examples as disclosed herein. For example, the communications manager 820 may be configured as or otherwise support a means for transmitting a capability message indicating a first quantity of candidate cells supported by the UE for a first type of mobility procedure. The communications manager 820 may be configured as or otherwise support a means for receiving, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure. The communications manager 820 may be configured as or otherwise support a means for receiving a downlink control channel order that instructs the UE to transmit a random access channel message to a candidate cell of the one or more candidate cells in accordance with the first type of mobility procedure.

By including or configuring the communications manager 820 in accordance with examples as described herein, the device 805 may support techniques for reduced latency for handover between cells, improved communication reliability, improved user experience related to reduced processing, reduced power consumption, more efficient utilization of communication resources, improved coordination between devices, and an improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of timing advanced measurement for candidate cells as described herein, or the processor 840 and the memory 830 may be otherwise configured to perform or support such operations.

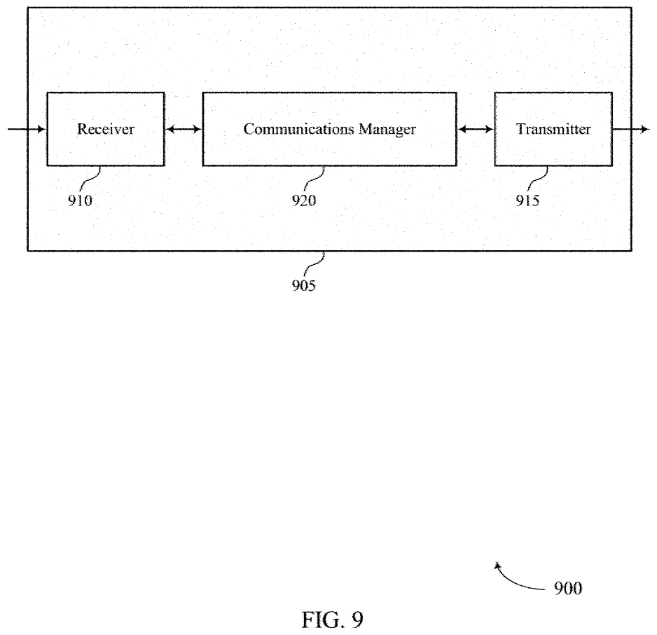

FIG. 9 illustrates a block diagram 900 of a device 905 that supports timing advanced measurement for candidate cells in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas.

Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of timing advanced measurement for candidate cells as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 may be configured as or otherwise support a means for receiving a capability message indicating a first quantity of candidate cells supported by a UE for a first type of mobility procedure. The communications manager 920 may be configured as or otherwise support a means for transmitting, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure. The communications manager 920 may be configured as or otherwise support a means for transmitting a downlink control channel order that instructs the UE to transmit a random access channel message to a candidate cell of the one or more candidate cells in accordance with the first type of mobility procedure.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced latency for handover between cells, reduced processing, reduced power consumption, and a more efficient utilization of communication resources.

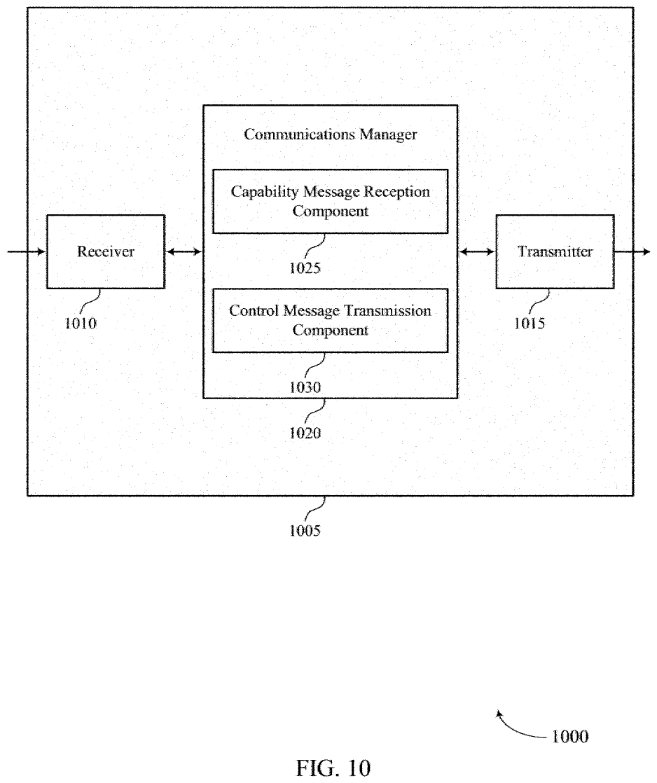

FIG. 10 illustrates a block diagram 1000 of a device 1005 that supports timing advanced measurement for candidate cells in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas.

Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of timing advanced measurement for candidate cells as described herein. For example, the communications manager 1020 may include a capability message reception component 1025 a control message transmission component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The capability message reception component 1025 may be configured as or otherwise support a means for receiving a capability message indicating a first quantity of candidate cells supported by a UE for a first type of mobility procedure. The control message transmission component 1030 may be configured as or otherwise support a means for transmitting, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure. The control message transmission component 1030 may be configured as or otherwise support a means for transmitting a downlink control channel order that instructs the UE to transmit a random access channel message to a candidate cell of the one or more candidate cells in accordance with the first type of mobility procedure.

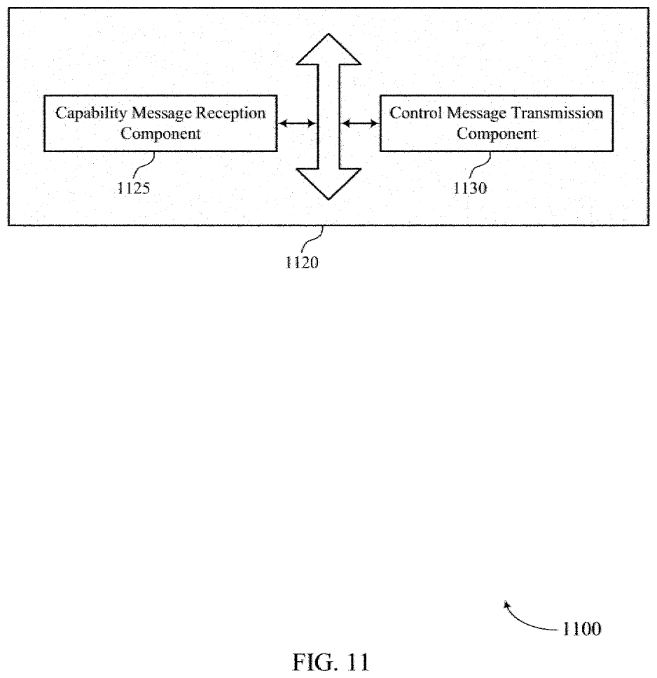

FIG. 11 illustrates a block diagram 1100 of a communications manager 1120 that supports timing advanced measurement for candidate cells in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of timing advanced measurement for candidate cells as described herein. For example, the communications manager 1120 may include a capability message reception component 1125 a control message transmission component 1130, or any combination thereof.

Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The capability message reception component 1125 may be configured as or otherwise support a means for receiving a capability message indicating a first quantity of candidate cells supported by a UE for a first type of mobility procedure. The control message transmission component 1130 may be configured as or otherwise support a means for transmitting, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure. In some examples, the control message transmission component 1130 may be configured as or otherwise support a means for transmitting a downlink control channel order that instructs the UE to transmit a random access channel message to a candidate cell of the one or more candidate cells in accordance with the first type of mobility procedure.

In some examples, to support receiving the capability message, the capability message reception component 1125 may be configured as or otherwise support a means for receiving, as part of the capability message, an indication of a threshold quantity of bands supported by the UE for transmission of the random access channel message.

In some examples, the indication includes a list of bands supported by the UE for transmission of the random access channel message. In some examples, the indication indicates whether each band of the list of bands supports uplink transmission, downlink reception, or both.

In some examples, to support receiving the capability message, the capability message reception component 1125 may be configured as or otherwise support a means for receiving, as part of the capability message, an indication of a set of guard periods, where each guard period of the set of guard periods includes a respective duration between receiving the downlink control channel order and the UE transmitting the random access channel message.

In some examples, a first guard period of the set of guard periods is associated with candidate cells included in the one or more candidate cells indicated by the control message and. In some examples, a second guard period of the set of guard periods is associated with candidate cells excluded from the one or more candidate cells indicated by the control message, the first guard period being less than the second guard period.

In some examples, a third guard period of the set of guard periods is associated with candidate cells associated with a same band as a current serving cell of the UE and. In some examples, a fourth guard period of the set of guard periods is associated with candidate cells associated with a different band than the current serving cell, the third guard period being less than the fourth guard period.

In some examples, each guard period of the set of guard periods includes a single latency value indicative of the respective duration or a set of latency values indicative of the respective duration.

In some examples, each guard period of the set of guard periods is associated with a respective candidate cell supported by the UE, a respective candidate cell group supported by the UE, or both.

In some examples, to support transmitting the control message, the control message transmission component 1130 may be configured as or otherwise support a means for transmitting a RRC message, a MAC-CE, or DCI.

In some examples, the second quantity of candidate cells is less than or equal to the first quantity of candidate cells.

In some examples, the first type of mobility procedure is a LI mobility procedure or a L2 mobility procedure.

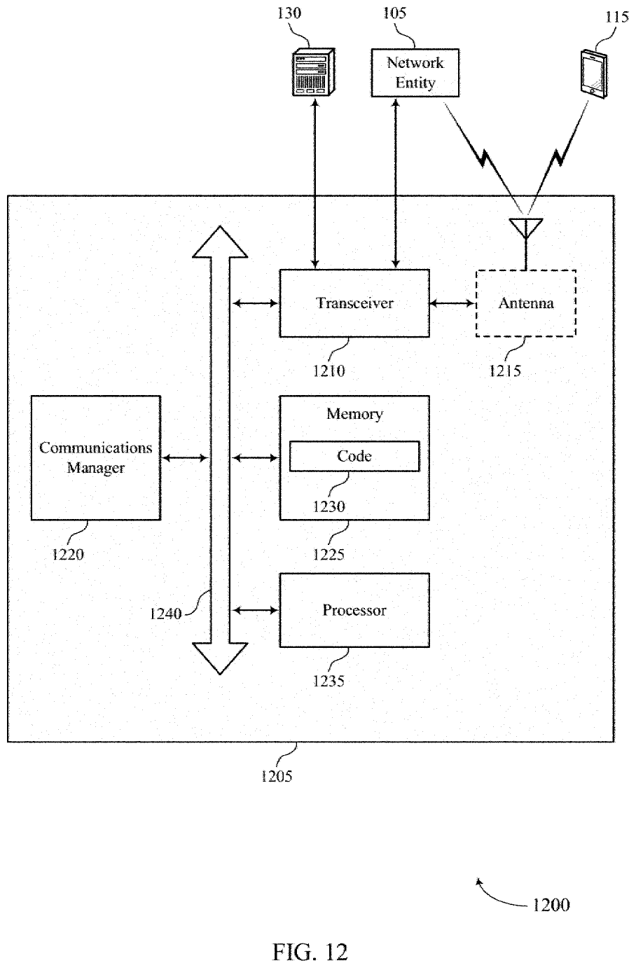

FIG. 12 illustrates a diagram of a system 1200 including a device 1205 that supports timing advanced measurement for candidate cells in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting timing advanced measurement for candidate cells). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 may be configured as or otherwise support a means for receiving a capability message indicating a first quantity of candidate cells supported by a UE for a first type of mobility procedure. The communications manager 1220 may be configured as or otherwise support a means for transmitting, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure. The communications manager 1220 may be configured as or otherwise support a means for transmitting a downlink control channel order that instructs the UE to transmit a random access channel message to a candidate cell of the one or more candidate cells in accordance with the first type of mobility procedure.

By including or configuring the communications manager 1220 in accordance with examples as described herein, the device 1205 may support techniques for reduced latency for handover between cells, improved communication reliability, improved user experience related to reduced processing, reduced power consumption, more efficient utilization of communication resources, improved coordination between devices, and an improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of timing advanced measurement for candidate cells as described herein, or the processor 1235 and the memory 1225 may be otherwise configured to perform or support such operations.

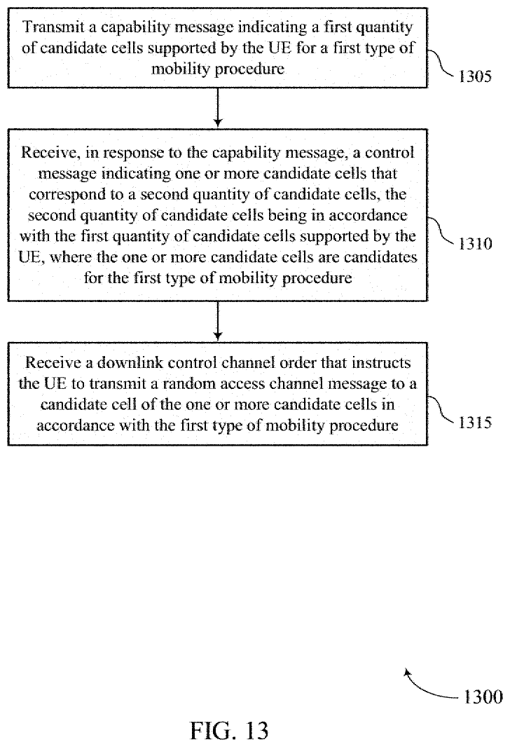

FIG. 13 illustrates a flowchart showing a method 1300 that supports timing advanced measurement for candidate cells in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting a capability message indicating a first quantity of candidate cells supported by the UE for a first type of mobility procedure. The operations of 1305 may be performed in accordance with examples as disclosed herein. In some examples, aspects of the operations of 1305 may be performed by a capability message transmission component 725 as described with reference to FIG. 7.

At 1310, the method may include receiving, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure. The operations of 1310 may be performed in accordance with examples as disclosed herein. In some examples, aspects of the operations of 1310 may be performed by a control message reception component 730 as described with reference to FIG. 7.

At 1315, the method may include receiving a downlink control channel order that instructs the UE to transmit a random access channel message to a candidate cell of the one or more candidate cells in accordance with the first type of mobility procedure. The operations of 1315 may be performed in accordance with examples as disclosed herein. In some examples, aspects of the operations of 1315 may be performed by a control message reception component 730 as described with reference to FIG. 7.

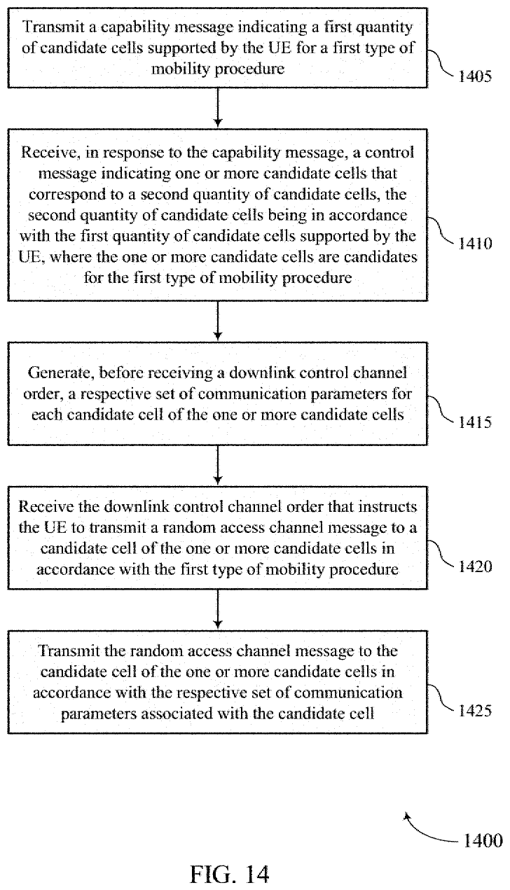

FIG. 14 illustrates a flowchart showing a method 1400 that supports timing advanced measurement for candidate cells in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting a capability message indicating a first quantity of candidate cells supported by the UE for a first type of mobility procedure. The operations of 1405 may be performed in accordance with examples as disclosed herein. In some examples, aspects of the operations of 1405 may be performed by a capability message transmission component 725 as described with reference to FIG. 7.

At 1410, the method may include receiving, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure. The operations of 1410 may be performed in accordance with examples as disclosed herein. In some examples, aspects of the operations of 1410 may be performed by a control message reception component 730 as described with reference to FIG. 7.

At 1415, the method may include generating, before receiving the downlink control channel order, a respective set of communication parameters for each candidate cell of the one or more candidate cells. The operations of 1415 may be performed in accordance with examples as disclosed herein. In some examples, aspects of the operations of 1415 may be performed by a parameter generation component 735 as described with reference to FIG. 7.

At 1420, the method may include receiving a downlink control channel order that instructs the UE to transmit a random access channel message to a candidate cell of the one or more candidate cells in accordance with the first type of mobility procedure. The operations of 1420 may be performed in accordance with examples as disclosed herein. In some examples, aspects of the operations of 1420 may be performed by a control message reception component 730 as described with reference to FIG. 7.

At 1425, the method may include transmitting the random access channel message to the candidate cell of the one or more candidate cells in accordance with the respective set of communication parameters associated with the candidate cell. The operations of 1425 may be performed in accordance with examples as disclosed herein. In some examples, aspects of the operations of 1425 may be performed by a PRACH transmission component 740 as described with reference to FIG. 7.

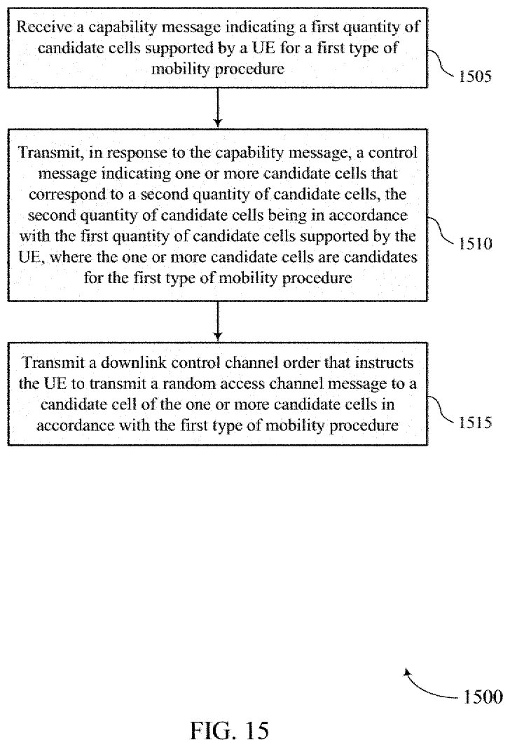

FIG. 15 illustrates a flowchart showing a method 1500 that supports timing advanced measurement for candidate cells in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include receiving a capability message indicating a first quantity of candidate cells supported by a UE for a first type of mobility procedure. The operations of 1505 may be performed in accordance with examples as disclosed herein. In some examples, aspects of the operations of 1505 may be performed by a capability message reception component 1125 as described with reference to FIG. 11.

At 1510, the method may include transmitting, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure. The operations of 1510 may be performed in accordance with examples as disclosed herein. In some examples, aspects of the operations of 1510 may be performed by a control message transmission component 1130 as described with reference to FIG. 11.

At 1515, the method may include transmitting a downlink control channel order that instructs the UE to transmit a random access channel message to a candidate cell of the one or more candidate cells in accordance with the first type of mobility procedure. The operations of 1515 may be performed in accordance with examples as disclosed herein. In some examples, aspects of the operations of 1515 may be performed by a control message transmission component 1130 as described with reference to FIG. 11.

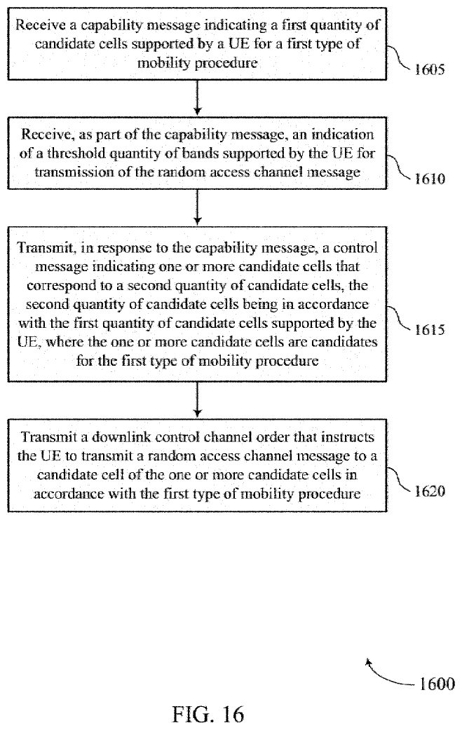

FIG. 16 illustrates a flowchart showing a method 1600 that supports timing advanced measurement for candidate cells in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include receiving a capability message indicating a first quantity of candidate cells supported by a UE for a first type of mobility procedure. The operations of 1605 may be performed in accordance with examples as disclosed herein. In some examples, aspects of the operations of 1605 may be performed by a capability message reception component 1125 as described with reference to FIG. 11.

At 1610, the method may include receiving, as part of the capability message, an indication of a threshold quantity of bands supported by the UE for transmission of the random access channel message. The operations of 1610 may be performed in accordance with examples as disclosed herein. In some examples, aspects of the operations of 1610 may be performed by a capability message reception component 1125 as described with reference to FIG. 11.

At 1615, the method may include transmitting, in response to the capability message, a control message indicating one or more candidate cells that correspond to a second quantity of candidate cells, the second quantity of candidate cells being in accordance with the first quantity of candidate cells supported by the UE, where the one or more candidate cells are candidates for the first type of mobility procedure. The operations of 1615 may be performed in accordance with examples as disclosed herein. In some examples, aspects of the operations of 1615 may be performed by a control message transmission component 1130 as described with reference to FIG. 11.

At 1620, the method may include transmitting a downlink control channel order that instructs the UE to transmit a random access channel message to a candidate cell of the one or more candidate cells in accordance with the first type of mobility procedure. The operations of 1620 may be performed in accordance with examples as disclosed herein. In some examples, aspects of the operations of 1620 may be performed by a control message transmission component 1130 as described with reference to FIG. 11.

The following provides an overview of aspects of the present disclosure:
Aspect 1: A method for wireless communications, at a UE, comprising: transmitting a capability message indicating a first quantity of candidate cells supported by the UE for a first type of mobility procedure; receiving, in response to the capability message, a control message indicating one or more candidate cells that correspond to a second quantity of candidate cells, the second quantity of candidate cells being in accordance with the first quantity of candidate cells supported by the UE, wherein the one or more candidate cells are candidates for the first type of mobility procedure; and receiving a downlink control channel order that instructs the UE to transmit a random access channel message to a candidate cell of the one or more candidate cells in accordance with the first type of mobility procedure.
Aspect 2: The method of aspect 1, further comprising: generating, before receiving the downlink control channel order, a respective set of communication parameters for each candidate cell of the one or more candidate cells; and transmitting the random access channel message to the candidate cell of the one or more candidate cells in accordance with the respective set of communication parameters associated with the candidate cell.
Aspect 3: The method of aspect 2, wherein receiving the control message comprises: receiving, as part of the control message, an indication of a time duration to generate each respective set of communication parameters, wherein generating the respective set of communication parameters for each candidate cell of the one or more candidate cells is based at least in part on the time duration.
Aspect 4: The method of any of aspects 2 through 3, further comprising: storing, at the UE, each respective set of communication parameters, wherein each respective set of communication parameters comprises a gain stage setting, a radio frequency filter configuration, an envelope tracking configuration, a radio frequency switch configuration, or a combination thereof.
Aspect 5: The method of any of aspects 1 through 4, wherein transmitting the capability message comprises: transmitting, as part of the capability message, an indication of a threshold quantity of bands supported by the UE for transmission of the random access channel message.
Aspect 6: The method of aspect 5, wherein the indication comprises a list of bands supported by the UE for transmission of the random access channel message, and the indication indicates whether each band of the list of bands supports uplink transmission, downlink reception, or both.
Aspect 7: The method of any of aspects 1 through 6, wherein transmitting the capability message comprises: transmitting, as part of the capability message, an indication of a set of guard periods, wherein each guard period of the set of guard periods comprises a respective duration between receiving the downlink control channel order and the UE transmitting the random access channel message.
Aspect 8: The method of aspect 7, wherein a first guard period of the set of guard periods is associated with candidate cells comprised in the one or more candidate cells indicated by the control message and a second guard period of the set of guard periods is associated with candidate cells excluded from the one or more candidate cells indicated by the control message, the first guard period being less than the second guard period.
Aspect 9: The method of any of aspects 7 through 8, wherein a third guard period of the set of guard periods is associated with candidate cells associated with a same band as a current serving cell of the UE and a fourth guard period of the set of guard periods is associated with candidate cells associated with a different band than the current serving cell, the third guard period being less than the fourth guard period.
Aspect 10: The method of any of aspects 7 through 9, wherein each guard period of the set of guard periods comprises a single latency value indicative of the respective duration or a set of latency values indicative of the respective duration.
Aspect 11: The method of any of aspects 7 through 10, wherein each guard period of the set of guard periods is associated with a respective candidate cell supported by the UE, a respective candidate cell group supported by the UE, or both.
Aspect 12: The method of any of aspects 1 through 11, wherein receiving the control message comprises: receiving a radio resource control message, a medium access control control element, or downlink control information.
Aspect 13: The method of any of aspects 1 through 12, wherein the second quantity of candidate cells is less than or equal to the first quantity of candidate cells.
Aspect 14: The method of any of aspects 1 through 13, wherein the first type of mobility procedure is a layer 1 mobility procedure or a layer 2 mobility procedure.
Aspect 15: The method of any of aspects 1 through 14, further comprising: transmitting, to the candidate cell of the one or more candidate cells, the random access channel message using a periodic, semi-persistent, or aperiodic transmission scheme.
Aspect 16: The method of any of aspects 1 through 15, wherein the random access channel message is associated with time advance measurement for the candidate cell of the one or more candidate cells.
Aspect 17: The method of any of aspects 1 through 16, wherein the first quantity of candidate cells comprises serving cells configured for uplink, downlink, or both.
Aspect 18: The method of any of aspects 1 through 17, wherein the first quantity of candidate cells comprises serving cells with a same center frequency as at least one candidate cell supported by the UE.
Aspect 19: The method of any of aspects 1 through 18, wherein the first quantity of candidate cells are associated with a same band or a same band combination.
Aspect 20: The method of any of aspects 1 through 19, wherein the first quantity of candidate cells comprise candidate cells used for downlink synchronization maintenance.
Aspect 21: A method for wireless communications, at a network entity, comprising: receiving a capability message indicating a first quantity of candidate cells supported by a UE for a first type of mobility procedure; transmitting, in response to the capability message, a control message indicating one or more candidate cells that correspond to a second quantity of candidate cells, the second quantity of candidate cells being in accordance with the first quantity of candidate cells supported by the UE, wherein the one or more candidate cells are candidates for the first type of mobility procedure; and transmitting a downlink control channel order that instructs the UE to transmit a random access channel message to a candidate cell of the one or more candidate cells in accordance with the first type of mobility procedure.
Aspect 22: The method of aspect 21, wherein receiving the capability message comprises: receiving, as part of the capability message, an indication of a threshold quantity of bands supported by the UE for transmission of the random access channel message.
Aspect 23: The method of aspect 22, wherein the indication comprises a list of bands supported by the UE for transmission of the random access channel message, and the indication indicates whether each band of the list of bands supports uplink transmission, downlink reception, or both.
Aspect 24: The method of any of aspects 21 through 23, wherein receiving the capability message comprises: receiving, as part of the capability message, an indication of a set of guard periods, wherein each guard period of the set of guard periods comprises a respective duration between receiving the downlink control channel order and the UE transmitting the random access channel message.
Aspect 25: The method of aspect 24, wherein a first guard period of the set of guard periods is associated with candidate cells comprised in the one or more candidate cells indicated by the control message and a second guard period of the set of guard periods is associated with candidate cells excluded from the one or more candidate cells indicated by the control message, the first guard period being less than the second guard period.
Aspect 26: The method of any of aspects 24 through 25, wherein a third guard period of the set of guard periods is associated with candidate cells associated with a same band as a current serving cell of the UE and a fourth guard period of the set of guard periods is associated with candidate cells associated with a different band than the current serving cell, the third guard period being less than the fourth guard period.
Aspect 27: The method of any of aspects 24 through 26, wherein each guard period of the set of guard periods comprises a single latency value indicative of the respective duration or a set of latency values indicative of the respective duration.
Aspect 28: The method of any of aspects 24 through 27, wherein each guard period of the set of guard periods is associated with a respective candidate cell supported by the UE, a respective candidate cell group supported by the UE, or both.
Aspect 29: The method of any of aspects 21 through 28, wherein transmitting the control message comprises: transmitting a radio resource control message, a medium access control control element, or downlink control information.
Aspect 30: The method of any of aspects 21 through 29, wherein the second quantity of candidate cells is less than or equal to the first quantity of candidate cells.
Aspect 31: The method of any of aspects 21 through 30, wherein the first type of mobility procedure is a layer 1 mobility procedure or a layer 2 mobility procedure.
Aspect 32: An apparatus for wireless communications, comprising a processor; memory coupled with the processor; and instructions stored in the memory and executable by the processor to cause the apparatus to perform a method of any of aspects 1 through 20.
Aspect 33: An apparatus for wireless communications, comprising at least one means for performing a method of any of aspects 1 through 20.
Aspect 34: A non-transitory computer-readable medium storing code for wireless communications, the code comprising instructions executable by a processor to perform a method of any of aspects 1 through 20.
Aspect 35: An apparatus for wireless communications, comprising a processor; memory coupled with the processor; and instructions stored in the memory and executable by the processor to cause the apparatus to perform a method of any of aspects 21 through 31.
Aspect 36: An apparatus for wireless communications, comprising at least one means for performing a method of any of aspects 21 through 31.
Aspect 37: A non-transitory computer-readable medium storing code for wireless communications, the code comprising instructions executable by a processor to perform a method of any of aspects 21 through 31.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers.

Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications, at a user equipment (UE), comprising:
a processor;
memory coupled with the processor; and
instructions stored in the memory and executable by the processor to cause the apparatus to:
transmit a capability message indicating a first quantity of candidate cells supported by the UE for a first type of mobility procedure;
receive, in response to the capability message, a control message indicating one or more candidate cells that correspond to a second quantity of candidate cells, the second quantity of candidate cells being in accordance with the first quantity of candidate cells supported by the UE, wherein the one or more candidate cells are candidates for the first type of mobility procedure; and
receive a downlink control channel order that instructs the UE to transmit a random access channel message to a candidate cell of the one or more candidate cells in accordance with the first type of mobility procedure.

2. The apparatus of claim 1, wherein the instructions are further executable by the processor to cause the apparatus to:
generate, before receiving the downlink control channel order, a respective set of communication parameters for each candidate cell of the one or more candidate cells; and
transmit the random access channel message to the candidate cell of the one or more candidate cells in accordance with the respective set of communication parameters associated with the candidate cell.

3. The apparatus of claim 2, wherein the instructions to receive the control message are executable by the processor to cause the apparatus to:
receive, as part of the control message, an indication of a time duration to generate each respective set of communication parameters, wherein generating the respective set of communication parameters for each candidate cell of the one or more candidate cells is based at least in part on the time duration.

4. The apparatus of claim 2, wherein the instructions are further executable by the processor to cause the apparatus to:
store, at the UE, each respective set of communication parameters, wherein each respective set of communication parameters comprises a gain stage setting, a radio frequency filter configuration, an envelope tracking configuration, a radio frequency switch configuration, or a combination thereof.

5. The apparatus of claim 1, wherein the instructions to transmit the capability message are executable by the processor to cause the apparatus to:
transmit, as part of the capability message, an indication of a threshold quantity of bands supported by the UE for transmission of the random access channel message.

6. The apparatus of claim 5, wherein the indication comprises a list of bands supported by the UE for transmission of the random access channel message, and the indication indicates whether each band of the list of bands supports uplink transmission, downlink reception, or both.

7. The apparatus of claim 1, wherein the instructions to transmit the capability message are executable by the processor to cause the apparatus to:
transmit, as part of the capability message, an indication of a set of guard periods, wherein each guard period of the set of guard periods comprises a respective duration between receiving the downlink control channel order and the UE transmitting the random access channel message.

8. The apparatus of claim 7, wherein a first guard period of the set of guard periods is associated with candidate cells comprised in the one or more candidate cells indicated by the control message and a second guard period of the set of guard periods is associated with candidate cells excluded from the one or more candidate cells indicated by the control message, the first guard period being less than the second guard period.

9. The apparatus of claim 7, wherein a third guard period of the set of guard periods is associated with candidate cells associated with a same band as a current serving cell of the UE and a fourth guard period of the set of guard periods is associated with candidate cells associated with a different band than the current serving cell, the third guard period being less than the fourth guard period.

10. The apparatus of claim 7, wherein each guard period of the set of guard periods comprises a single latency value indicative of the respective duration or a set of latency values indicative of the respective duration.

11. The apparatus of claim 7, wherein each guard period of the set of guard periods is associated with a respective candidate cell supported by the UE, a respective candidate cell group supported by the UE, or both.

12. The apparatus of claim 1, wherein the instructions to receive the control message are executable by the processor to cause the apparatus to:
receive a radio resource control message, a medium access control control element, or downlink control information.

13. The apparatus of claim 1, wherein the second quantity of candidate cells is less than or equal to the first quantity of candidate cells.

14. The apparatus of claim 1, wherein the first type of mobility procedure is a layer 1 mobility procedure or a layer 2 mobility procedure.

15. The apparatus of claim 1, wherein the instructions are further executable by the processor to cause the apparatus to:
transmit, to the candidate cell of the one or more candidate cells, the random access channel message using a periodic, semi-persistent, or aperiodic transmission scheme.

16. The apparatus of claim 1, wherein the random access channel message is associated with time advance measurement for the candidate cell of the one or more candidate cells.

17. The apparatus of claim 1, wherein the first quantity of candidate cells comprises serving cells configured for uplink, downlink, or both.

18. The apparatus of claim 1, wherein the first quantity of candidate cells comprises serving cells with a same center frequency as at least one candidate cell supported by the UE.

19. The apparatus of claim 1, wherein the first quantity of candidate cells are associated with a same band or a same band combination.

20-28. (canceled)

29. A method for wireless communications, at a user equipment (UE), comprising:
transmitting a capability message indicating a first quantity of candidate cells supported by the UE for a first type of mobility procedure,
receiving, in response to the capability message, a control message indicating one or more candidate cells that correspond to a second quantity of candidate cells, the second quantity of candidate cells being in accordance with the first quantity of candidate cells supported by the UE, wherein the one or more candidate cells are candidates for the first type of mobility procedure; and
receiving a downlink control channel order that instructs the UE to transmit a random access channel message to a candidate cell of the one or more candidate cells in accordance with the first type of mobility procedure.

30. (canceled)
